(19) United States
(12) Patent Application Publication
(10) Pub. No.: US 2026/0212048 A1
(43) Pub. Date: Jul. 23, 2026

(54) Method for protecting a terminal against a side-channel attack

(71) Applicant: BANKS AND ACQUIRERS INTERNATIONAL HOLDING, SURESNES (FR)

(72) Inventor: Vincent GIRAUD, PARIS (FR)

(21) Appl. No.: 19/136,576

(22) PCT Filed: Dec. 5, 2023
(86) PCT No.: PCT/EP2023/084333

§ 371 Date: Jun. 20, 2025

(30) Foreign Application Priority Data
Dec. 6, 2022 (FR) FR2212834

(51) Int. Cl. G06F 21/75; G06F 21/81

(52) U.S. Cl. CPC G06F 21/755; G06F 21/81

(57) ABSTRACT

A method for protecting a terminal including a data processor, a battery and a battery gauge providing the data processor with data descriptive of the state of the battery, against a side-channel attack using the data descriptive of the state of the battery. The method includes implementing, by the data processor: when said terminal is likely to be subject to said attack, controlling at least one energy-consuming component of the terminal so as to modify the data descriptive of the state of the battery provided by the battery gauge.

### CROSS-REFERENCE TO RELATED APPLICATIONS

This Application is a Section 371 National Stage Application of International Application No. PCT/EP 2023/084333, filed Dec. 5, 2023, and published as WO 2024/121142 A1 on Jun. 13, 2024, not in English, which claims priority to and the benefit of French Patent Application No. 2212834, filed Dec. 6, 2022, the contents of which are incorporated herein by reference in their entireties.

### GENERAL TECHNICAL FIELD

The present invention relates to the field of computer security. More specifically, it concerns a method for protecting a terminal against a side-channel attack.

### PRIOR ART

Smartphone-type mobile terminals now store a large amount of personal user data and are used for sensitive operations such as transactions. Securing them is therefore a necessity, and attack attempts to compromise their content are increasingly frequent.

A side-channel attack (SCA) is a computer attack which, without calling into question the theoretical robustness of security methods and procedures, seeks out and exploits flaws in their implementation, whether software or hardware.

More specifically, while an algorithm may be perfectly mathematically secure, hardware-related flaws may nevertheless appear during “practical” use, and allow, for example, obtaining a secret information such as a user's authentication code.

A typical example is fault injection, that is to say the deliberate introduction of errors into the system to provoke certain revealing behaviors.

More recently, acoustic or consumption attacks consist in studying either the noise generated by the processor (it emits noise which varies in intensity and nature depending on its consumption), or directly its power consumption to give details about the code.

Indeed, each instruction executed by a microprocessor uses a certain number of transistors. At any time, the measurement of the current consumed can reflect the activity of the microprocessor. Certain more expensive operations therefore increase the power consumption, so that it is possible in particular to distinguish differences between valid and invalid codes.

Side-channel attacks are numerous and varied, difficult to predict, and it is therefore desirable to make them impossible.

The invention aims to improve the situation.

### SUMMARY

The present invention therefore relates, according to a first aspect, to a method for protecting a terminal comprising data processing means, a battery and a battery gauge providing the data processing means with data descriptive of the state of the battery, against a side-channel attack using said data descriptive of the state of the battery, the method being characterized in that it comprises the implementation by the data processing means of steps of:
(b) When said terminal is likely to be subject to said attack, controlling at least one energy-consuming component of the terminal so as to modify the data descriptive of the state of the battery provided by the battery gauge.

According to advantageous and non-limiting features:
Said energy-consuming component is a vibrator.

The method comprises a step (a) of requesting entry of a code on an interface of the terminal, step (b) being implemented during the entry of said code by a user on said interface.

The data processing means are configured to activate said vibrator each time a character of said code is entered on the interface.

In step (b), said energy-consuming component of the terminal is controlled either to be activated at least once in a dummy manner, or to be temporarily deactivated.

In step (b), either said vibrator or another energy-consuming component of the terminal is controlled to be activated in a dummy manner outside of an entry of a character of said code on the interface, or said vibrator is controlled not to be activated when entering at least one character of said code on the interface.

The method comprises a step (c) of detecting whether said attack is attempted based on the modified data descriptive of the state of the battery following step (b).

Step (b) simulates the implementation of a target process on the terminal by controlling the energy-consuming component so as to obtain the same data descriptive of the state of the battery as those that would be obtained for said target process.

The target process is entering a code on an interface of the terminal.

The method comprises a step (d) of implementing a response measure based on the result of step (c).

Said response measure comprises a software blocking of the data descriptive of the state of the battery provided by the battery gauge.

According to a second aspect, the invention concerns a terminal comprising data processing means, at least one energy-consuming component, a battery and a battery gauge providing the data processing means with data descriptive of the state of the battery, the data processing means being configured to:
When said terminal is likely to be subject to a side-channel attack using said data descriptive of the state of the battery, control said energy-consuming component so as to modify the data descriptive of the state of the battery provided by the battery gauge.

According to a third and a fourth aspect, the invention concerns a computer program product comprising code instructions for the execution of a method, according to the first aspect, for protecting a terminal comprising data processing means, a battery and a battery gauge providing the data processing means with data descriptive of the state of the battery, against a side-channel attack using said data descriptive of the state of the battery; and a storage means readable by computer equipment on which is recorded a computer program product comprising code instructions for the execution of a method, according to the first aspect, for protecting a terminal comprising data processing means, a battery and a battery gauge providing the data processing means with data descriptive of the state of the battery, against a side-channel attack using said data descriptive of the state of the battery.

### PRESENTATION OF THE FIGURES

Other features and advantages of the present invention will become apparent upon reading the following description of a preferred embodiment. This description will be given with reference to the appended drawings in which:

FIG. 1 represents an example of a mobile terminal with a battery gauge;

FIG. 2 illustrates a side-channel attack using the data descriptive of the state of the battery;

FIG. 3 is a diagram of a system for implementing the method according to the invention;

FIG. 4 is a flowchart illustrating the steps of an embodiment of the method according to the invention.

### DETAILED DESCRIPTION

### New Attack

The inventors discovered that advances in battery-powered mobile terminals such as smartphones make possible a new type of side-channel attack by analyzing power consumption (which, however, has little to do with known attacks of this type).

This is paradoxical because the continuous search for improving the autonomy of these terminals has led to increasing the energy efficiency of electronic components (to reduce consumption) to such an extent that variations in consumption have become almost imperceptible, and therefore power analysis attacks have become much more complex.

However, to optimize the charge and discharge cycles of batteries (and avoid a decrease in their capacity), these batteries have been made smart by adding turnkey components to the terminals (that is to say with their own data processing means, of the microcontroller type) dedicated to controlling the remaining state of charge “SoC”, called “fuel gauge”, by analogy with the fuel gauges in vehicles. The term “battery gauge” will be used, even if the term “fuel gauge” is the one commonly used by those skilled in the art.

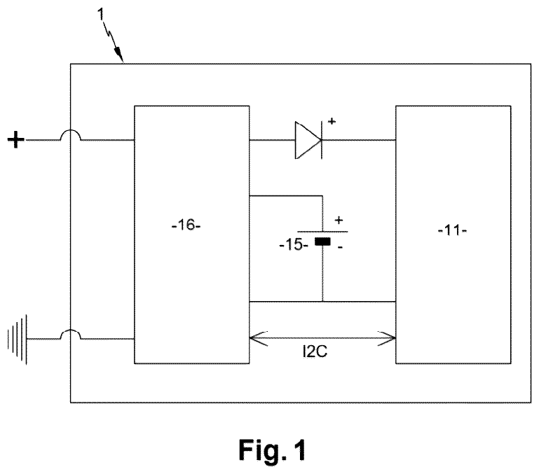

With reference to FIG. 1, in a conventional manner, data processing means 11 (for example a processor), the battery 15 and the battery gauge 16 are represented in a terminal 1. It can be seen that the battery gauge 16 is mounted so that:
the gauge 16 is connected to the posts of the battery 15;
The means 11 (and generally the components of terminal 1) are powered via the gauge 16;
Data is exchanged between the gauge 16 and the data processing means via a computer bus (such as I2C).

The gauge 16 is configured to continuously acquire data descriptive of the state of the battery 15 (generally current, voltage across its posts, remaining state of charge and often temperature) and communicate this information to the data processing means 11 via said bus. All this data can be measured and/or calculated, in this respect the gauge 15 can use any known battery capacity deduction technique, such as one based on the voltage measurement (by estimating the internal resistance and applying the discharge curve), or on the incoming and outgoing charge measurement by modeling the self-discharge as a function of the temperature (a technique known as the “Coulomb counter”).

In a particularly efficient manner, the battery gauge 16 can in addition combine the two techniques: the voltage measurement is performed when the battery 15 is not under load; and the current measurement is performed when the battery 15 receives or delivers energy.

Thus, the battery voltage is used to update its current state of charge based on the curve of its voltage evolution as a function of its remaining capacity. Then, when a load is applied to it, the Coulomb counter method is used to measure the energy entering and leaving the system. Using both voltage and charge measurements, the maximum capacity of the battery can be estimated. The internal resistance of the battery can also be calculated using the measured current, and the two battery voltages with and without load. Thus, with the maximum capacity of the battery and its internal resistance, an accurate value of the remaining capacity can be obtained.

On terminals 1 equipped with an operating system (OS), the latter may or may not choose to leave the information sent by the battery gauge 16 (data descriptive of the state of the battery 15) accessible to applications. For example, on an Android environment, this data can be actively relayed at the request of an application, without permission required.

The inventors found that this functionality represents a security risk, likely to open the door to a new side-channel attack. Indeed, each application is in fact granted read rights (since the requests are relayed by the OS) but also write rights (since by triggering more or less intensive use of various components, the application de facto influences the metric measured by these sensors).

Tests showed that by using a deliberately developed malicious application, the attacker was able to recover a PIN code entered by a user, despite the software isolation between applications proposed by the operating system.

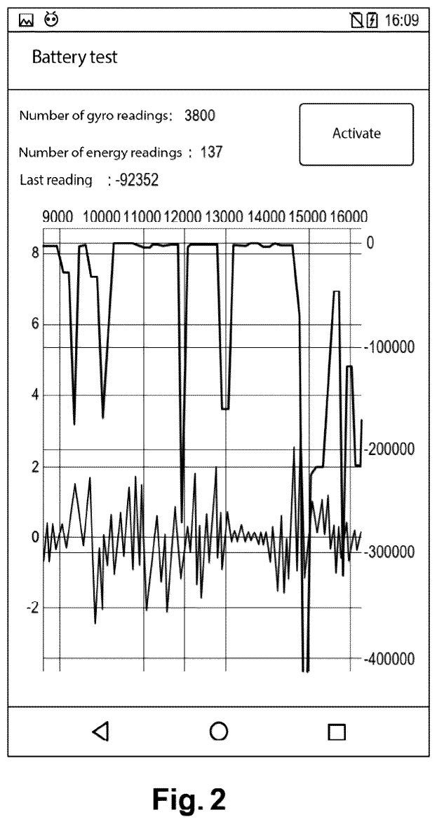

In FIG. 2, the top peaks represent the interception of touches on the numeric keyboard based on the battery gauge 16 data. It should be noted that most phones, in their factory settings, activate the vibrator upon each touch, making malicious detection even easier.

Once this data has been collected, a temporal analysis can be conducted. Indeed, knowing the layout of the keyboard, it is possible to exploit the constraints it implies, and the distance between all the keys. A simple script gives, for a sequence of durations between touches, the set of possible PIN codes, which can even be reduced by using gyroscopic data with simple assumptions (example: it is known that a right-handed person will make a characteristic movement to touch the 1 on the keyboard with his/her thumb, as it is the furthest key from the latter).

It will be understood that the present new side-channel attack using the data descriptive of the state of the battery 15 provided by the gauge 16 has little to do with the known power analysis attacks of the data processing means 11:
The new attack does not seek to distinguish processor operations, but directly to detect particular user actions by their impact on the battery;
The new attack theoretically allows directly obtaining one or several probable codes, and not just knowing whether an entered code is correct or not.

### Method

The present invention concerns a method for protecting a terminal 1 against the new side-channel attack which has just been described, which would exploit the data from the battery gauge 16.

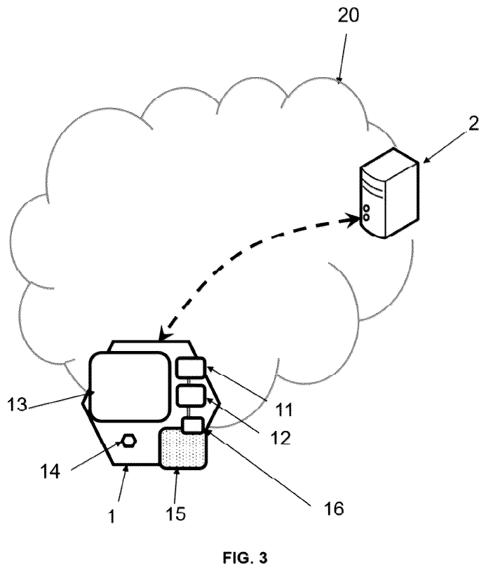

With reference to FIG. 3, the terminal 1 therefore comprises:
the data processing means 11,
generally data storage means 12 (a battery), an interface 13 such as a touch screen capable of displaying a virtual keyboard and/or a physical keyboard
a battery 15, powering at least the data processing means 11 (and in practice the entire terminal 1-it should be noted that the terminal 1 can generally be connected to the mains to recharge the battery 15, but in practice the terminal is always powered by the battery 15, and thus the terminal 1 is said to be “battery-powered”);
a battery gauge 16 providing the data processing means 11 with data descriptive of the state of the battery 15, it is recalled that this data can be a voltage across the posts of the battery 15 (in V), a current (in A) and/or a remaining charge of the battery 15 (in Ah).

The terminal 1 is typically a mobile terminal such as a smartphone, a touchscreen tablet, but also an EPT, or any battery-powered device

Furthermore, the terminal 1 comprises at least one “energy-consuming component” 11, 12, 13, 14, also powered by the battery. By energy-consuming component, it should be understood a component having, when activated, a significant consumption, that is to say having on the battery 15 an impact that can be detected by the battery gauge 16. To further restate, the consumption (in mAh, or rather μAh) of an activation of said energy-consuming component is greater than a predefined detection threshold.

Said energy-consuming component 11, 12, 13, 14 may be the processing means 11, the data storage means 12, the interface 13, but also a vibrator 14 of the terminal 1. This is typically in a virtual keyboard context in which the data processing means 11 are configured to activate said vibrator 14 each time a character is entered on the interface 13 (that is to say each time the virtual keyboard is touched). Indeed, this enables “haptic feedback” in which the user has the sensation of using a real keyboard. Alternatively, the energy-consuming component could be a speaker, an antenna, a camera, a flash, a GPS chip, etc.

It should be noted that the terminal 1 can be connected, for example, via a network 10 such as the Internet to a server 2 centralizing the fight against the side-channel attack.

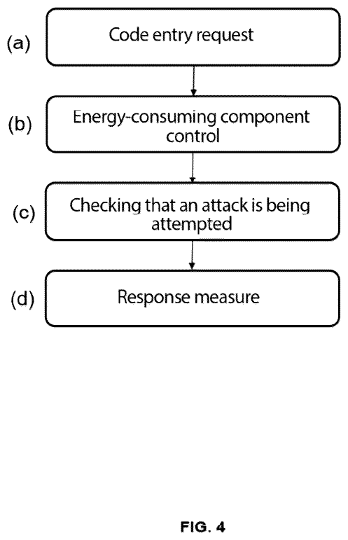

With reference to FIG. 4, the present method, implemented by the data processing means 11 of the terminal 1, mainly comprises a step (b), implemented when said terminal 1 is likely to be subject to said side-channel attack, of controlling at least one energy-consuming component 11, 12, 13, 14 of the terminal 1 so as to modify the data descriptive of the state of the battery 15 provided by the battery gauge 16.

The criterion “when said terminal 1 is likely to be subject to said side-channel attack” typically corresponds:
either to an identified attack context, for example the server 2 can warn the terminal 1 that it has detected suspicious activity;
or to a sensitive use of terminal 1, in particular the entry of a code on the interface 13 for example to implement a transaction, access personal data, etc.

Taking the latter case as an example, the method thus begins with a step (a) of requesting entry of the code on the interface 13, and said control of the energy-consuming component 11, 12, 13, 14 of the terminal 1 so as to modify the data descriptive of the state of the battery 15 provided by the battery gauge 16 is implemented during the entry of said code by a user on said interface 13 (that is to say in this case “When said terminal 1 is likely to be subject to said attack”=“during the entry of the code”). It should be noted that if the data processing means 11 are configured to activate said vibrator 14 each time a character is entered on the interface 13, it is supposed to have an activation of the vibrator 14 each time a character of the code is entered, which makes the side-channel attack easy since it is an energy-consuming component.

By control of the energy-consuming component 11, 12, 13, 14, it should be understood an “unpredictable” use of this component which will modify its consumption and therefore disrupt the data descriptive of the state of the battery 15. To restate, the battery gauge 16 will continue to send the data descriptive of the state of the battery 15, but these will have been “scrambled” by the energy-consuming component and made unusable for the side-channel attack, which will therefore fail.

In particular, the energy component is controlled:
either to be activated at least once in a dummy manner (that is to say it is activated for nothing, at a time when it should not have been activated, to create parasitic consumption),
or to be temporarily deactivated (that is to say it is not activated, at a time when it should have been, to create parasitic underconsumption).

It should be noted that preferably, the control of this component is such that the general operation of the terminal 1, and therefore the user experience, are not disrupted. Moreover, it is preferentially random to prevent an attacker from being able to predict the disruption and take it into account.

In the preferred example of entering a code, the vibrator 14 is controlled as follows:
either to be activated in a dummy manner outside of an entry of a character of said code on the interface 13 (that is to say it creates a parasitic consumption and simulates a non-existent/different key entry), it should be noted that another energy-consuming component 11, 12, 13 can be used instead of the vibrator 14 to create said parasitic consumption,
or to not be activated when entering at least one character of said code on the interface 13 (that is to say it hides an actual key entry).

Preferably, there are at least, upon entering the code:
a legitimate activation of the vibrator 14 (when entering a character of the code);
a dummy activation of the vibrator 14 (outside of any entry of a character of the code)
a lack of legitimate activation of the vibrator 14 (when entering a character of the code).

As an alternative to the vibrator 14, the following energy-consuming component controls can be performed:
the implementation of a dummy operation on the data processing means 11;
a dummy memory write (in particular if the means 12 are a hard disk);
a dummy display (or a lack of display) on the interface 13;
a sound emission from the loudspeaker at a high volume but at an inaudible or almost inaudible frequency such as 5 Hz.

### Diagnostic or Provocation Modes

In another embodiment, the aim is to prevent the side-channel attack, either by checking to what extent the terminal 1 is vulnerable, or by actively encouraging the attacker to act to flush him out (active defense technique known as honeypot).

To do this, step (b) simulates the implementation of a target process on the terminal 1 by controlling the energy-consuming component 11, 12, 13, 14 so as to obtain the same consumption profile (the same data descriptive of the state of the battery 15) as that which would be obtained on said target process.

Typically, the target process is the entry of a code (in particular a decoy code -that is to say a given code different from an expected code, which as will be seen can constitute a “signature” of an attack) on an interface 13 of the terminal 1, so that said entry of the code is simulated, for example by activating the vibrator 14 so as to reproduce the sequence that would be obtained when entering a decoy code.

There may of course always be the step (a) of requesting entry of a code on the interface 13 of the terminal 1, as it is this step which can attract the attacker and trigger the observation of said data descriptive of the state of the battery 15 (with a view to committing the side-channel attack).

The difference is that there is no need for user intervention (that is to say preferably step (b) does not include the entry of a code by the user on the interface 13), the terminal 1 can itself fully simulate the entry of said code by a user on said interface 13, which enables a completely automatic mode. To restate, after step (a), instead of waiting for the user to enter the expected code (his real code), the terminal 1 simulates the entry of a given decoy code, and the attacker does not make the difference. Alternatively, the user can still enter his code but we make sure to simulate the entry of the given decoy code which is different from the code entered by the user, that is to say the expected code (by making sure to specifically obtain the data descriptive of the state of the battery 15 that would have been obtained for the entry of this decoy code-by adapting the energy consumption).

It is then possible to see whether it is easy to find the decoy code from the modified data descriptive of the state of the battery 15 (by the activation of the vibrator 14) provided by the battery gauge 16 (which would reveal a vulnerability the user can simply be alerted, various checks can be set up (responses to requests, at what frequency, with what precision, etc.) in order to obtain a assessment of the risks incurred, and these results can be presented to the user or used by a sensitive software solution to better evaluate its environment), or even implement a step (c) of detecting whether said attack is attempted based on the modified data descriptive of the state of the battery 15 following step (b).

This approach opens up the possibility of trapping an attacker, by looking to see if there is an attempt to use the decoy code later, it is possible to determine that the system is under attack, or under active surveillance, and act accordingly. In other words, the attack (c) is typically a step of detecting a use of the decoy code. Indeed, the decoy code cannot appear by chance, it is a signature: it can only be obtained by having obtained the modified data descriptive of the state of the battery 15 and its use is therefore proof of the attack (and in doing so the attacker who used this decoy code exposes himself).

To this end, the method may comprise a step (d) of implementing a response measure based on the result of step (c), which may range from simply alerting the user, to attempting to identify and neutralize the attacker, through complete software blocking (at least temporarily) of the data descriptive of the state of the battery 15 provided by the battery gauge 16 (that is to say the data processing means 11 prevent other applications from having access to it). This may temporarily harm the battery life (as the applications will no longer be able to finely optimize the energy consumption), but the risk of a real attack will be eliminated.

### Terminal

According to a second aspect, the invention concerns the terminal 1 for implementing the method according to the first aspect.

Thus, this terminal 1 comprises, as explained, data processing means 11, at least one energy-consuming component 11, 12, 13, 14 (typically a vibrator 14), a battery 15 and a battery gauge 16 providing the data processing means 11 with data descriptive of the state of the battery 15. It may further comprise data storage means 12, an interface 13, etc.

The data processing means 11 are configured to implement steps aimed at protecting the terminal 1 against a side-channel attack using said data descriptive the state of the battery 15, these steps consisting in:
When said terminal 1 is likely to be subject to such a side-channel attack using said data descriptive of the state of the battery 15 (for example when entering a code on the interface 13), controlling said energy-consuming component 11, 12, 13, 14 so as to modify the data descriptive of the state of the battery 15 provided by the battery gauge 16;
Where appropriate, detecting whether said attack is attempted based on the modified data descriptive of the state of the battery 15; or even implementing a response measure based on the result of the detection.

### Computer Program Product

According to a fourth and a fifth aspect, the invention concerns a computer program product comprising code instructions for the execution (on the data processing means 11 of the terminal 1) of a method, according to the first aspect, for protecting the terminal 1 against a side-channel attack using said data descriptive of the state of the battery 15 provided by the battery gauge 16, as well as storage means readable by computer equipment (for example the data storage means 12 of the terminal) on which this computer program product is found.

Although the present disclosure has been described with reference to one or more examples, workers skilled in the art will recognize that changes may be made in form and detail without departing from the scope of the disclosure and/or the appended claims.

1. A method comprising:
for protecting a terminal comprising a data processor, a battery and a battery gauge providing the data processor with data descriptive of a state of the battery, against a side-channel attack using said data descriptive of state of the battery, the protecting comprising implementing by the data processor:
when said terminal is likely to be subject to said attack, simulating implementation of a target process on the terminal by controlling at least one energy-consuming component of the terminal so as to modify the data descriptive of the state of the battery provided by the battery gauge and obtain a same data descriptive of the state of the battery as the data that would be obtained for said target process; and
detecting whether said attack is attempted based on the modified data descriptive of the state of the battery.

2. The method according to claim 1, wherein said energy-consuming component is a vibrator.

3. The method according to claim 1, comprising requesting entry of a code on an interface of the terminal, the simulating being implemented during the entry of said code by a user on said interface.

4. The method according to claim 3, wherein said energy-consuming component is a vibrator and wherein the data processor is configured to activate said vibrator each time a character of said code is entered on the interface.

5. The method according to claim 1, wherein in the simulating, said energy-consuming component of the terminal is controlled either to be activated at least once in a dummy manner, or to be temporarily deactivated.

6. The method according to claim 4, wherein in the simulating, said energy-consuming component of the terminal is controlled either to be activated at least once in a dummy manner, or to be temporarily deactivated, and either said vibrator or another energy-consuming component of the terminal is controlled to be activated in a dummy manner outside of an entry of a character of said code on the interface, or said vibrator is controlled not to be activated when entering at least one character of said code on the interface.

7. The method according to claim 1, wherein the target process is the entry of a code on an interface of the terminal.

8. The method according to claim 1, comprising implementing a response measure based on a result of the detecting.

9. The method according to claim 8, wherein said response measure comprises a software blocking of the data descriptive of the state of the battery provided by the battery gauge.

10. A terminal comprising:
data processor,
at least one energy-consuming component,
a battery, and
a battery gauge which provides the data processor with data descriptive of a state of the battery,
the data processor being configured to:
when said terminal is likely to be subject to a side-channel attack using said data descriptive of the state of the battery, simulate implementation of a target process on the terminal by controlling said energy-consuming component so as to modify the data descriptive of the state of the battery provided by the battery gauge and obtain a same data descriptive of the state of the battery as would be obtained for said target process; and
detect whether said attack is attempted based on the modified data descriptive of the state of the battery.

11. (canceled)

12. A non-transitory computer readable storage medium on which is recorded a computer program product comprising code instructions for the execution of a method when the instructions are executed by a data processor of a terminal, wherein the method comprises:
protecting the terminal, which comprises the data processor, a battery and a battery gauge providing the data processor with data descriptive of a state of the battery, against a side-channel attack using said data descriptive of the state of the battery, the protecting comprising:
when said terminal is likely to be subject to said attack, simulating implementation of a target process on the terminal by controlling at least one energy-consuming component of the terminal so as to modify the data descriptive of the state of the battery provided by the battery gauge and obtain a same data descriptive of the state of the battery as the data that would be obtained for said target process; and
detecting whether said attack is attempted based on the modified data descriptive of the state of the battery.
